(19) United States
(12) Patent Application Publication
(10) Pub. No.: US 2007/0124392 A1
(43) Pub. Date: May 31, 2007

(54) Mutual awareness between blind carbon copy recipients of electronic mail messages

(75) Inventor: Itzhack Goldberg, Hadera (IL)

Correspondence Address: Stephen C. Kaufman;IBM CORPORATION, Intellectual Property Law Dept., P.O. Box 218, Yorktown Heights, NY, 10598, US

(73) Assignee: International Business Machines Corporation, Armonk, NY (US)

(21) Appl. No.: 11/289,963

(22) Filed: Nov. 30, 2005

(51) Int. Cl. G06F 15/16

(52) U.S. Cl. 709/206

(57) ABSTRACT

A method for providing mutual awareness between blind carbon copy recipients of electronic mail messages, including identifying a blind carbon copy group (BCCG) of addressees defined for an email message, and sending the email message to the BCCG addressees, where each of the email messages sent includes the addresses of each of the addressees in the BCCG.

### FIELD OF THE INVENTION

The present invention relates to electronic mail messaging in general, and more particularly to managing mutual awareness between recipients of electronic mail messages.

### BACKGROUND OF THE INVENTION

The success of electronic mail, or email, as a communications medium can be attributed in part to the establishment and acceptance of standards that ensure that email messages can be readily exchanged between different computing platforms and environments. These standards define the structure of email messages, as well as the protocols and mechanisms used to transport and deliver those messages. Among these standards are those that define the structure of email messages as having a header and a body. Well known among header fields are the TO, CC, and BCC addressing fields. Standard use of the TO and CC fields allow an addressee appearing in these fields to see who are the other addressees in these fields, while an addressee appearing in the BCC field, or blind carbon copy field, does not see the other BCC addressees.

One situation that current email addressing standards do not address may be illustrated by the following example. A company employee wishes to send an email regarding a customer who requires assistance that requires the involvement of several other individuals within the company. The employee would like to notify the customer that help is on the way, while at the same time apprise the relevant parties within the company of the situation. Using the TO field for the customer's address and the BCC field for the addresses of the relevant parties within the company would allow the relevant parties within the company to be notified, while preventing the customer from contacting the BCC recipients directly, which would be desirable from the company's point of view. However, using the BCC field would prevent the relevant parties within the company from being aware of each other's involvement, whereas if each was aware that the others received the same email, they would be able to cooperate more efficiently.

### SUMMARY OF THE INVENTION

The present invention discloses a system and method for hiding BCC addressees from TO and CC addressees, while providing mutual awareness among BCC addressees.

In one aspect of the present invention a method is provided for providing mutual awareness between blind carbon copy recipients of electronic mail messages, the method including identifying a blind carbon copy group (BCCG) of addressees defined for an email message, and sending the email message to the BCCG addressees, where each of the email messages sent includes the addresses of each of the addressees in the BCCG.

In another aspect of the present invention the sending step includes preserving the BCCG field in the email message sent.

In another aspect of the present invention the sending step includes indicating the BCCG addressees within the body of the email message sent.

In another aspect of the present invention the sending step includes indicating the BCCG addressees in either of the TO or CC fields of the email message sent.

In another aspect of the present invention the method further includes identifying a second BCCG of addressees defined for the email message, and sending the email message to the addressees in the second BCCG, where each of the email messages sent to the second BCCG addressees includes the addresses of each of the addressees in the second BCCG, where each of the email messages sent to the first-mentioned BCCG addressees does not include the addresses of each of the addressees in the second BCCG, and where each of the email messages sent to the second BCCG addressees does not include the addresses of each of the addressees in the first-mentioned BCCG.

In another aspect of the present invention the method further includes providing the blind carbon group (BCCG) field for use with the email message.

In another aspect of the present invention the sending step includes delivering the email message to the BCCG field addressees, where each of the delivered email messages includes the addresses of each of the addressees in the BCCG

In another aspect of the present invention the delivering step includes preserving the BCCG field in the delivered email message.

In another aspect of the present invention the delivering step includes indicating the BCCG addressees within the body of the delivered email message.

In another aspect of the present invention the delivering step includes indicating the BCCG addressees in either of the TO or CC fields of the delivered email message.

In another aspect of the present invention the method further includes providing a second BCCG field for use with the email message, and delivering the email message to at least one addressee in the second BCCG field, where each of the email messages delivered to the second BCCG addressees includes the addresses of each of the addressees in the second BCCG field, where each of the email messages delivered to the first-mentioned BCCG addressees does not include the addresses of each of the addressees in the second BCCG field, and where each of the email messages delivered to the second BCCG addressees does not include the addresses of each of the addressees in the first-mentioned BCCG field.

In another aspect of the present invention a system is provided for providing mutual awareness between blind carbon copy recipients of electronic mail messages, the system including a blind carbon copy group (BCCG) of addressees defined for an email message, and a computer for sending the email message to the BCCG addressees, where each of the email messages sent includes the addresses of each of the addressees in the BCCG.

In another aspect of the present invention the computer is operative to perform any of a) preserving the BCCG field in the email message sent, b) indicating the BCCG addressees within the body of the email message sent, and c) indicating the BCCG addressees in either of the TO or CC fields of the email message sent.

In another aspect of the present invention the computer is operative to identify a second BCCG of addressees defined for the email message, and send the email message to the addressees in the second BCCG, where each of the email messages sent to the second BCCG addressees includes the addresses of each of the addressees in the second BCCG, where each of the email messages sent to the first-mentioned BCCG addressees does not include the addresses of each of the addressees in the second BCCG, and where each of the email messages sent to the second BCCG addressees does not include the addresses of each of the addressees in the first-mentioned BCCG.

In another aspect of the present invention further includes a blind carbon group (BCCG) field for use with the email message.

In another aspect of the present invention the computer is operative to deliver the email message to the BCCG field addressees, where each of the delivered email messages includes the addresses of each of the addressees in the BCCG

In another aspect of the present invention the computer is operative to perform any of a) preserving the BCCG field in the delivered email message, b) indicating the BCCG addressees within the body of the delivered email message, and c) indicating the BCCG addressees in either of the TO or CC fields of the delivered email message.

In another aspect of the present invention the system further includes a second BCCG field for use with the email message, and where the computer is operative to deliver the email message to at least one addressee in the second BCCG field, where each of the email messages delivered to the second BCCG addressees includes the addresses of each of the addressees in the second BCCG field, where each of the email messages delivered to the first-mentioned BCCG addressees does not include the addresses of each of the addressees in the second BCCG field, and where each of the email messages delivered to the second BCCG addressees does not include the addresses of each of the addressees in the first-mentioned BCCG field.

In another aspect of the present invention a method is provided for providing mutual awareness between blind carbon copy recipients of electronic mail messages, the method including configuring an email program that is executable by a computer to provide a blind carbon copy group (BCCG) of addressees defined for an email message, and configuring the email program to deliver the email message to the BCCG addressees, where each of the delivered email messages includes the addresses of each of the addressees in the BCCG.

In another aspect of the present invention a computer-implemented program is provided embodied on a computer-readable medium, the computer-implemented program including a first code segment operative to identify a blind carbon copy group (BCCG) of addressees defined for an email message, and a second code segment operative to deliver the email message to the BCCG addressees, where each of the delivered email messages includes the addresses of each of the addressees in the BCCG.

### BRIEF DESCRIPTION OF THE DRAWINGS

The present invention will be understood and appreciated more fully from the following detailed description taken in conjunction with the appended drawings in which:

FIG. 1 is a simplified conceptual illustration of a system for providing mutual awareness among blind carbon copy recipients of email messages, constructed and operative in accordance with a preferred embodiment of the present invention; and

FIG. 2 is a simplified flowchart illustration of an exemplary method of operation of the system of FIG. 1, operative in accordance with a preferred embodiment of the present invention.

### DETAILED DESCRIPTION OF THE INVENTION

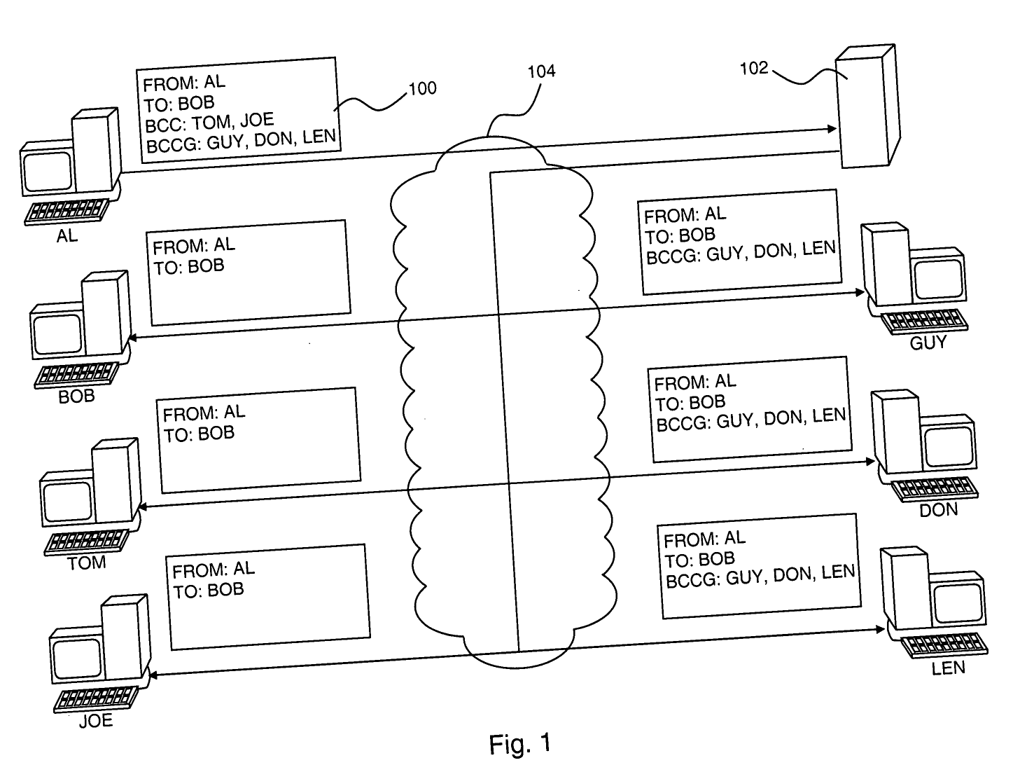

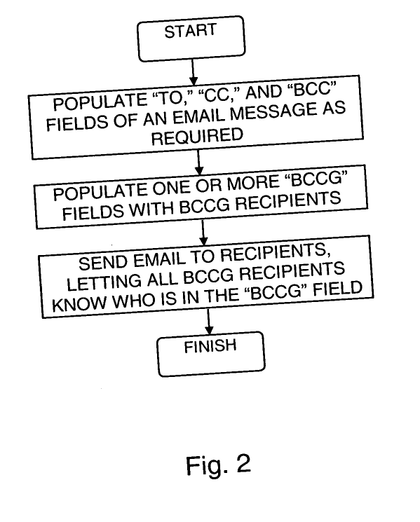

Reference is now made to FIG. 1, which is a simplified conceptual illustration of a system for providing mutual awareness among blind carbon copy recipients of email messages, constructed and operative in accordance with a preferred embodiment of the present invention, and additionally to FIG. 2, which is a simplified flowchart illustration of an exemplary method of operation of the system of FIG. 1, operative in accordance with a preferred embodiment of the present invention. In the system and method of FIGS. 1 and 2, a computer user named Al wishes to send an email message 100 to a computer user named Bob. To accomplish this, Al employs an email program that is executable by Al's computer and configured for use with the present invention, and places Bob's email address (shown as “Bob” for the sake of simplicity) in the TO field of email message 100. Al also wishes to send a blind carbon copy of email message 100 to computer users Tom and Joe, such that Bob will not know that Tom and Joe received blind carbon copies, and such that neither Tom nor Joe will know that the other is a blind carbon copy recipient. To accomplish this, Al places Tom and Joe's email addresses (shown as “Tom” and “Joe”) in the BCC field of email message 100.

Al also wishes to send a blind carbon copy of email message 100 to computer users Guy, Don, and Len, such that neither Bob nor Tom nor Joe will know that Guy, Don, and Len received blind carbon copies, and such that Guy, Don, and Len will each know that the other is a blind carbon copy recipient. In accordance with the present invention, Al accomplishes this by placing Guy, Don, and Len's email addresses (shown as “Guy,” “Don,” and “Len”) in a blind carbon copy group (BCCG) field of email message 100.

Al then sends email message 100 to an email server 102 via a network 104, such as the Internet. Server 102 forwards email message 100 to Bob, Tom, and Joe in accordance with standard email formatting, transport, and delivery protocols, where the identities of all blind carbon copy recipients are kept hidden from Bob, Tom, and Joe. In accordance with the present invention, server 102 identifies any addressees in a BCCG of email message 100 and forwards email message 100 for delivery to Guy, Don, and Len together with includes the addresses of each of said addressees in the BCCG such that each BCCG recipient may see who are the other BCCG recipients. This may be accomplished in a number of different ways, such as by preserving the BCCG field in the delivered message, by indicating within the body of email message 100 sent to Guy, Don, and Len that Guy, Don, and Len are blind carbon copy group recipients, or by placing Guy, Don, and Len's email addresses in the TO or CC fields of email message 100.

It will be appreciated that multiple BCCG fields may be used to define separate blind carbon copy groups, where recipients in a blind carbon copy group are aware of the other members in the group, but where recipients in one blind carbon copy group are hidden from the recipients in a different blind carbon copy group.

It is appreciated that one or more of the steps of any of the methods described herein may be omitted or carried out in a different order than that shown, without departing from the true spirit and scope of the invention.

While the methods and apparatus disclosed herein may or may not have been described with reference to specific computer hardware or software, it is appreciated that the methods and apparatus described herein may be readily implemented in computer hardware or software using conventional techniques.

While the present invention has been described with reference to one or more specific embodiments, the description is intended to be illustrative of the invention as a whole and is not to be construed as limiting the invention to the embodiments shown. It is appreciated that various modifications may occur to those skilled in the art that, while not specifically shown herein, are nevertheless within the true spirit and scope of the invention.

What is claimed is:

1. A method for providing mutual awareness between blind carbon copy recipients of electronic mail messages, the method comprising:
identifying a blind carbon copy group (BCCG) of addressees defined for an email message; and
sending said email message to said BCCG addressees, wherein each of said email messages sent includes the addresses of each of said addressees in said BCCG.

2. A method according to claim 1 wherein said sending step comprises preserving said BCCG field in said email message sent.

3. A method according to claim 1 wherein said sending step comprises indicating said BCCG addressees within the body of said email message sent.

4. A method according to claim 1 wherein said sending step comprises indicating said BCCG addressees in either of said TO or CC fields of said email message sent.

5. A method according to claim 1 and further comprising:
identifying a second BCCG of addressees defined for said email message; and
sending said email message to said addressees in said second BCCG,
wherein each of said email messages sent to said second BCCG addressees includes the addresses of each of said addressees in said second BCCG,
wherein each of said email messages sent to said first-mentioned BCCG addressees does not include the addresses of each of said addressees in said second BCCG, and
wherein each of said email messages sent to said second BCCG addressees does not include the addresses of each of said addressees in said first-mentioned BCCG.

6. A method according to claim 1 and further comprising:
providing said blind carbon group (BCCG) field for use with said email message.

7. A method according to claim 1 wherein said sending step comprises delivering said email message to said BCCG field addressees, wherein each of said delivered email messages includes the addresses of each of said addressees in said BCCG

8. A method according to claim 7 wherein said delivering step comprises preserving said BCCG field in said delivered email message.

9. A method according to claim 7 wherein said delivering step comprises indicating said BCCG addressees within the body of said delivered email message.

10. A method according to claim 7 wherein said delivering step comprises indicating said BCCG addressees in either of said TO or CC fields of said delivered email message.

11. A method according to claim 7 and further comprising:
providing a second BCCG field for use with said email message; and
delivering said email message to at least one addressee in said second BCCG field,
wherein each of said email messages delivered to said second BCCG addressees includes the addresses of each of said addressees in said second BCCG field,
wherein each of said email messages delivered to said first-mentioned BCCG addressees does not include the addresses of each of said addressees in said second BCCG field, and
wherein each of said email messages delivered to said second BCCG addressees does not include the addresses of each of said addressees in said first-mentioned BCCG field.

12. A system for providing mutual awareness between blind carbon copy recipients of electronic mail messages, the system comprising:
a blind carbon copy group (BCCG) of addressees defined for an email message; and
a computer for sending said email message to said BCCG addressees, wherein each of said email messages sent includes the addresses of each of said addressees in said BCCG.

13. A system according to claim 12 wherein said computer is operative to perform any of a) preserving said BCCG field in said email message sent, b) indicating said BCCG addressees within the body of said email message sent, and c) indicating said BCCG addressees in either of said TO or CC fields of said email message sent.

14. A system according to claim 12 wherein said computer is operative to:
identify a second BCCG of addressees defined for said email message; and
send said email message to said addressees in said second BCCG,
wherein each of said email messages sent to said second BCCG addressees includes the addresses of each of said addressees in said second BCCG,
wherein each of said email messages sent to said first-mentioned BCCG addressees does not include the addresses of each of said addressees in said second BCCG, and
wherein each of said email messages sent to said second BCCG addressees does not include the addresses of each of said addressees in said first-mentioned BCCG.

15. A system according to claim 12 and further comprising a blind carbon group (BCCG) field for use with said email message.

16. A system according to claim 15 wherein said computer is operative to deliver said email message to said BCCG field addressees, wherein each of said delivered email messages includes the addresses of each of said addressees in said BCCG

17. A system according to claim 16 wherein said computer is operative to perform any of a) preserving said BCCG field in said delivered email message, b) indicating said BCCG addressees within the body of said delivered email message, and c) indicating said BCCG addressees in either of said TO or CC fields of said delivered email message.

18. A system according to claim 16 and further comprising a second BCCG field for use with said email message, and wherein said computer is operative to deliver said email message to at least one addressee in said second BCCG field,
wherein each of said email messages delivered to said second BCCG addressees includes the addresses of each of said addressees in said second BCCG field,
wherein each of said email messages delivered to said first-mentioned BCCG addressees does not include the addresses of each of said addressees in said second BCCG field, and
wherein each of said email messages delivered to said second BCCG addressees does not include the addresses of each of said addressees in said first-mentioned BCCG field.

19. A method for providing mutual awareness between blind carbon copy recipients of electronic mail messages, the method comprising:
configuring an email program that is executable by a computer to provide a blind carbon copy group (BCCG) of addressees defined for an email message; and
configuring said email program to deliver said email message to said BCCG addressees, wherein each of said delivered email messages includes the addresses of each of said addressees in said BCCG.

20. A computer-implemented program embodied on a computer-readable medium, the computer-implemented program comprising:
a first code segment operative to identify a blind carbon copy group (BCCG) of addressees defined for an email message; and
a second code segment operative to deliver said email message to said BCCG addressees, wherein each of said delivered email messages includes the addresses of each of said addressees in said BCCG.
